(19) United States
(12) Patent Application Publication
(10) Pub. No.: US 2025/0033472 A1
(43) Pub. Date: Jan. 30, 2025

(54) ROTATABLE ELECTRONIC DEVICE

(71) Applicant: CLARION CORPORATION OF AMERICA, Auburn Hills, MI (US)

(72) Inventor: Mark MATHEWS, Lombard, IL (US)

(21) Appl. No.: 18/359,768

(22) Filed: Jul. 26, 2023

(51) Int. Cl. B60K 37/06; G06F 3/041; G06F 3/044

(52) U.S. Cl. CPC B60K 35/10; G06F 3/0412; G06F 3/0446; B60K 35/50; B60K 2360/126; B60K 2360/1438; B60K 2360/816

(57) ABSTRACT

A rotatable electronic device for installation onto a grid of sensor electrodes of a touch sensitive display panel. The rotatable device includes a fixed base and a knob assembly mounted over the fixed base. The fixed base has a bottom surface including a plurality of coupling electrodes. The coupling electrodes each align with and overlie at least one of the sensor electrodes when the rotatable electronic device is installed on the grid of sensor electrodes, such that two of the coupling electrodes align with and overlie a corresponding pair of edge-adjacent sensor electrodes of the grid. Manual rotation of the knob causes concomitant rotation of rotatable conductive regions in the knob, and manual depression of the knob causes a switch to change a coupling from one of two coupling electrodes to the other of the two of the coupling electrodes.

### TECHNICAL FIELD

The present disclosure is related generally to automotive displays, and more particularly, to rotatable electronic devices for touch sensitive display panels.

### BACKGROUND

Mechanical components such as rotatable knobs may be a desirable feature to integrate with touch sensitive display panels in vehicles. FIG. 1 shows a prior art rotatable knob 20 that is situated over a sensor grid 22. This knob and sensor grid is discussed, for example, in U.S. Pat. No. 10,921,913 to Synaptics Incorporated, and is incorporated by reference herein in its entirety. In the sensor grid 22, sensors 24, 26 are used to sense rotation of the knob 20, and sensor 28 is used to sense push/touch. Unused sensors 30, 32 are situated between active sensors 24, 26, 28. This arrangement may help to avoid crosstalk or parasitic capacitance between adjacent sensors. With two sensors that are edge adjacent (e.g., 24/30, 28/30, 26/32, 28/32), it may be difficult to sufficiently distinguish their states (e.g., signal/no signal).

Accordingly, a challenge exists when attempting to downsize the knob 20, given the constraints of the sensor grid 22. FIG. 1 illustrates a knob 20 that is about 40 mm in diameter. To avoid the edge adjacent active electrodes, the arrangement of FIG. 2 may be employed with active sensors 24, 26, 28, 34, and unused sensors 30, 32, 36. However, as illustrated, this knob 40 has to at least be about 30 mm in diameter. Anything smaller would result in active sensors that are edge-adjacent or too close for proper functioning.

### SUMMARY

An illustrative display panel for a vehicle includes a rotatable electronic device for installation onto a grid of sensor electrodes of a touch sensitive display panel. Each individual sensor electrode in the grid of sensor electrodes has a plurality of adjacent sensor electrodes, including a plurality of edge-adjacent electrodes and one or more diagonally-adjacent electrodes. The rotatable electronic device comprises a fixed base and a knob assembly mounted over the fixed base. The fixed base has a bottom surface and a top surface, the bottom surface including a plurality of coupling electrodes, and the top surface including a plurality of fixed conductive regions each electrically connected to a different one of the coupling electrodes. The coupling electrodes each align with and overlie at least one of the sensor electrodes when the rotatable electronic device is installed on the grid of sensor electrodes such that two of the coupling electrodes align with and overlie a corresponding pair of edge-adjacent sensor electrodes of the grid. The knob assembly includes a knob, a momentary switch, and a plurality of rotatable conductive regions which are configured to at least partially align with the fixed conductive regions of the fixed base. Manual rotation of the knob causes concomitant rotation of the rotatable conductive regions, and manual depression of the knob causes the switch to change a coupling from one of the two of the coupling electrodes to the other of the two of the coupling electrodes.

In various embodiments, the two coupling electrodes comprise first and second edge-adjacent coupling electrodes and the plurality of coupling electrodes comprises a third coupling electrode that is diagonally adjacent the first edge-adjacent coupling electrode and is remote from the second edge-adjacent coupling electrode.

In various embodiments, the plurality of coupling electrodes comprises a fourth coupling electrode that is diagonally adjacent the second edge-adjacent coupling electrode and is remote from the first edge-adjacent coupling electrode.

In various embodiments, the grid of sensor electrodes is organized into rows and columns of the sensor electrodes, and wherein the first, second, third, and fourth coupling electrodes are arranged on the fixed base such that, when the rotatable electronic device is installed on the grid of sensor electrodes with the first and second coupling electrodes aligned with and overlying sensor electrodes within either one single row or one single column of the grid, the third and fourth coupling electrodes are both aligned with and overlying sensor electrodes within either an adjacent single row or an adjacent single column, respectively.

In various embodiments, the knob assembly includes a rotary wheel having a bottom side that includes the rotatable conductive regions, the rotary wheel and switch being mounted within the knob, the knob being axially translatable between a raised position and a depressed position, wherein the knob is biased towards the raised position and, when manually moved to the depressed position, physically engages the switch to change it from a first state to a second state.

In various embodiments, the knob is an electrically conductive knob and the rotatable conductive regions include first and second radially spaced conductive rings, with the switch being connected in circuit between the conductive knob, the first conductive ring, and the second conductive ring such that, when the switch is in the first state, the switch electrically connects the conductive knob to the first conductive ring and, when the switch is in the second state, the switch electrically connects the conductive knob to the second conductive ring.

In various embodiments, the knob is biased towards the raised position by a plurality of metal springs and is electrically connected to the switch via at least one of the metal springs.

In various embodiments, each of the plurality of fixed conductive regions are configured to physically contact the bottom side of the rotary wheel at each of the rotatable conductive regions.

In various embodiments, the sensor electrodes have a width W and a height H, and the fixed base has an outer peripheral diameter in the range of 4 to 6 times the greater of W and H. In various embodiments, the lesser of W and H is greater than 0.8 times, and less than 1.0 times, greater of W and H.

In various embodiments, the rotatable wheel and fixed base are configured such that, when the rotatable electronic device is installed on the grid of sensor electrodes, the rotatable electronic device provides internal capacitive coupling to a first set of the sensor electrodes and external capacitive coupling to a second set of the sensor electrodes.

In various embodiments, the plurality of coupling electrodes include a pair of rotation sensing electrodes that, when the rotatable electronic device is installed on the grid of sensor electrodes, overlie and are aligned with a corresponding pair of sensor electrodes of the first set of sensor electrodes and wherein the plurality of coupling electrodes further include a touch coupling electrode and a push coupling electrode, wherein, when the rotatable electronic device is installed on the grid of sensor electrodes, the touch and push coupling electrodes overlie and are aligned with a corresponding pair of sensor electrodes of the second set of sensor electrodes.

In various embodiments, the touch and push coupling electrodes comprise the two coupling electrodes that, when the rotatable electronic device is installed on the grid of sensor electrodes, align with and overlie the pair of edge-adjacent sensor electrodes of the grid.

In various embodiments, an automotive display comprises the rotatable electronic device and display panel.

In various embodiments, the display panel is an in-cell touch and display driver integration display.

It is contemplated that any number of the individual features of the above-described embodiments and of any other embodiments depicted in the drawings or description below can be combined in any combination to define an invention, except where features are incompatible.

### BRIEF DESCRIPTION OF THE DRAWINGS

Illustrative embodiments will hereinafter be described in conjunction with the following figures, wherein like numerals denote like elements, and wherein:

FIG. 1 is a schematic view of a rotatable knob and sensor grid in accordance with the prior art;

FIG. 2 is an example schematic of a rotatable knob and sensor grid that is partially downsized;

FIG. 3 is an exploded view of an embodiment of a rotatable electronic device for installation onto a grid of sensor electrodes of a touch sensitive display panel, the rotatable electronic device having a knob and a fixed base that are joined to the touch sensitive display panel;

FIG. 4 is a schematic representation of the grid for the rotatable electronic device of FIG. 3;

FIG. 5 shows switch coupling electrodes on the rotatable electronic device, the positions of which are schematically overlayed in phantom on the grid of FIG. 4;

FIG. 6 shows a bottom surface of the fixed base of the rotatable electronic device of FIG. 3, with components of a top surface of the fixed base shown in phantom;

FIG. 7 shows the top surface of the fixed base of the rotatable electronic device of FIG. 3;

FIG. 8 shows a top surface of a rotary wheel with a switch used to selectively activate sensors in the sensor grid of FIG. 4, with portions of a bottom surface of the rotary wheel shown in phantom;

FIG. 9 shows the bottom surface of the rotary wheel of FIG. 8, with portions of the top surface shown in phantom;

FIG. 10 schematically shows the knob and switch of FIG. 3 with a schematic representation of a first state for the active sensors in the sensor grid of FIG. 4;

FIG. 11 schematically shows the knob and switch of FIG. 3 with a schematic representation of a second state for the active sensors in the sensor grid of FIG. 4;

FIG. 12 schematically illustrates the knob and sensor grid of FIG. 4, showing the accomplishable size differential;

FIG. 13 shows a top surface of another embodiment of a fixed base that can be used with the rotatable electronic device of FIG. 3; and

FIG. 14 shows a bottom surface of the fixed base of FIG. 13.

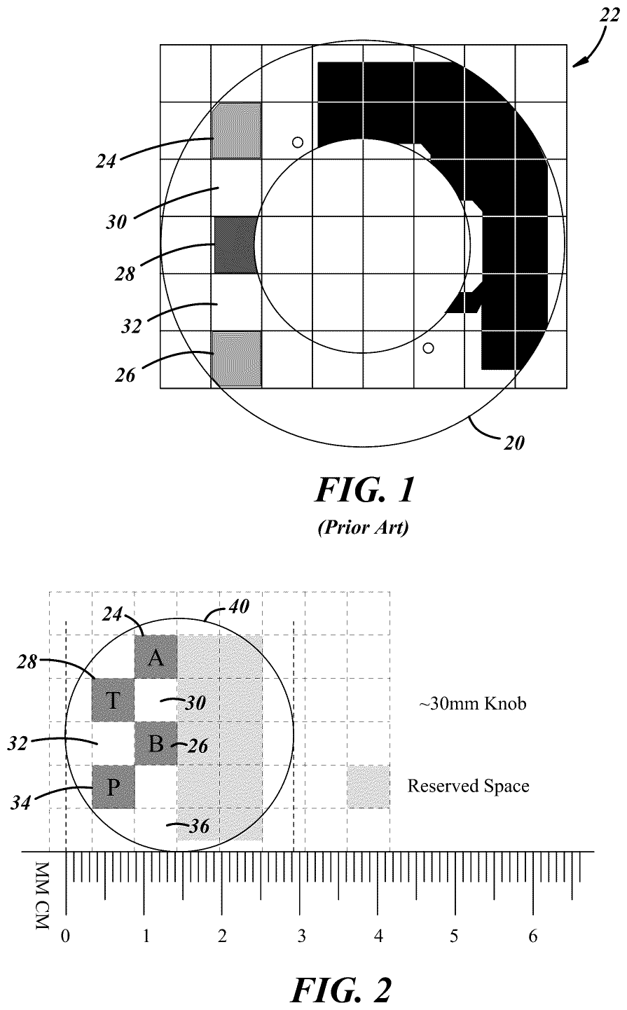

### DESCRIPTION OF ILLUSTRATIVE EMBODIMENTS

Described herein is a rotatable electronic device that is capable of using closely positioned sensors on a grid of sensor electrodes in a touch sensitive display panel. Normally, simultaneously employing edge-adjacent sensors can result in undesirable crosstalk or parasitic capacitance. In embodiments herein, however, the knob assembly of the rotatable electronic device can ultimately employ edge-adjacent sensors by switching the capacitive coupling from one edge-adjacent coupling electrode to another. This effectively prevents two edge-adjacent sensors from being active at the same time, while maintaining functionality (e.g., touch vs. push sensing while rotation sensing), obtaining a smaller size knob, and maintaining adequate signal discrimination.

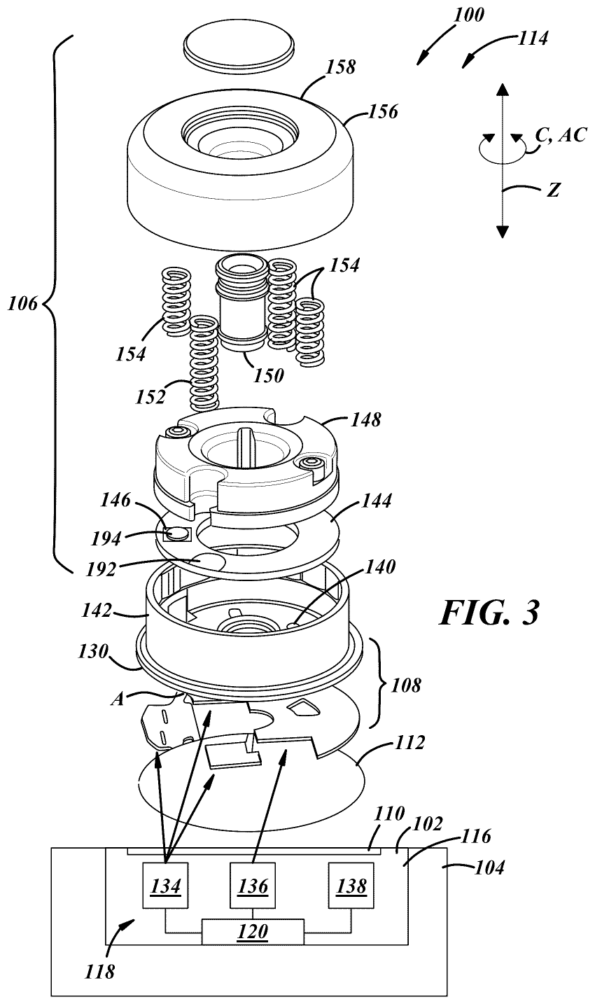

FIG. 3 is an exploded view of a rotatable electronic device 100 situated over a schematically illustrated touch sensitive display panel 102 installed in an automotive interior panel 104. The rotatable electronic device 100 comprises a knob assembly 106 mounted over, and rotatable relative to, a fixed base 108. The fixed base 108 of the rotatable electronic device 100 is installed on the display panel 102, and more particularly, onto a grid 110 of sensor electrodes of the display panel 102. An adhesive layer 112 can be used to attach the rotatable electronic device 100 onto the display panel 102, or other methods of attachment are certainly possible. Further, other layers and subcomponents may be included in addition to those particularly described with respect to the rotatable electronic device 100, such as one or more sensors, conductive electronic layers, or other functional and/or aesthetic subcomponents. Additionally, with respect to the display panel 102, there may be additional lenses, filters, protective layers, etc. depending on the desired implementation.

As will be detailed further below, the fixed base 108 of the rotatable electronic device 100 is installed to the display panel 102 such that there is not relative movement of the fixed base 108 with respect to the display panel 102, but then the knob assembly 106 portion of the rotatable electronic device 100 is configured to move with respect to the display panel 102 and the automotive interior panel 104. In this embodiment, the knob assembly 106 is configured to rotate clockwise and anticlockwise C, AC with respect to the display panel 102. Additionally, the knob assembly 106 is configured to be pushed in a Z-direction with respect to the display panel 102. The ultimate direction of movement will depend on the specifications for the automotive interior panel 104, and may vary from the schematic representation illustrated in FIG. 3. For example, the rotatable electronic device 100 may be used on an automotive display 114 to input information relating to the vehicle's infotainment or HVAC system, integrated on an instrument panel as the automotive interior panel 104. Other implementations are certainly possible, such as integration on automotive seats, the steering wheel, consoles, mirrors, door panels, etc. The movement of the electronic device 100 and resultant functionality may also vary from what is particularly described herein, but in this particular implementation, the rotation (C, AC) and push (Z) are efficiently accommodated.

The touch sensitive display panel 102 is advantageously an in-cell touch and display driver integration (TDDI) display 116, which includes the grid 110, integrated circuitry 118, and an application processor 120. The application processor 120 may include a processor and/or memory, a microprocessor, controller, transmitter/receiver, or in some embodiments, may be a separate controller, module or the like that is otherwise integrated with the vehicle. TDDI display 116 integrates the touch sensor grid 110 and display electrodes in a thin layer, and the rotatable electronic device 100 can employ features of the display panel 102 and touch sensor grid 110 to help impart functionality within the vehicle. Adjustment to the vehicle functionality (e.g., changing the temperature of the HVAC system by rotating the knob assembly 106 of the rotatable electronic device 100) will vary depending on the system specifications, and such adjustment may be accomplished in a number of ways. For example, input from the assembly 100 and the adjustment may be controlled via a dedicated microcontroller or processor, as discussed above, via another vehicle electronic device such as a body control module, or in another operable fashion.

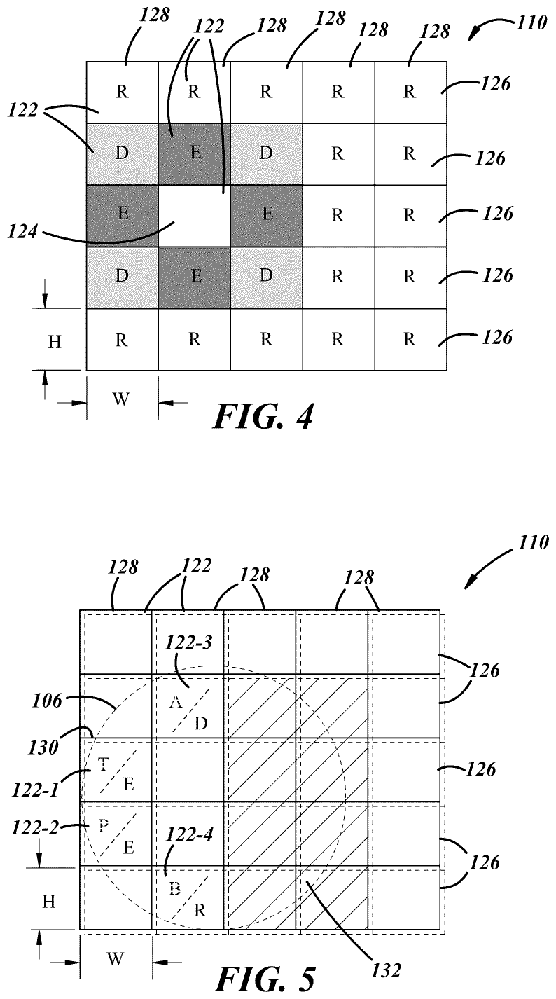

FIGS. 4 and 5 schematically illustrate the sensor grid 110 of the display panel 102. The grid 110 comprises a plurality of individual sensor electrodes 122 (only a few of the representative squares on the grid 110 are labeled for clarity purposes, but in the illustrated embodiment, the entirety of the grid 110 comprises the sensor electrodes 122). With respect to a reference electrode 124, it can be shown that each individual sensor electrode 122 includes a plurality of adjacent sensor electrodes D, E, including a plurality of edge-adjacent electrodes E and a plurality of diagonally-adjacent electrodes D. The edge-adjacent electrodes E share one or more complete, or sometimes partial, sides with a directly neighboring sensor electrode 122. The diagonally-adjacent electrodes D share a corner with one or more cater-cornered sensor electrodes 122. Additionally, a plurality of remote sensor electrodes R are spatially separated from the reference electrode 124 (and accordingly, from each individual sensor electrode 122). The remote sensor electrodes R are spatially separated from the reference electrode 124 by at least one of the adjacent sensor electrodes D, E. The reference electrode 124 may be in other locations on the sensor grid 110, as the alignment descriptions for adjacent sensor electrodes D, E, and the remote sensor electrodes R are used to positionally orient the individual sensor electrodes 122 with respect to each other.

The sensor grid 110 comprises a plurality of sensor rows 126 and sensor columns 128. Each sensor row 126 comprises a plurality of the individual sensor electrodes 122, and each sensor column 128 comprises a plurality of the individual sensor electrodes 122. The number of rows 126, columns 128, and individual sensor electrodes 122 will depend on the overall specifications for the display panel 102, and may vary from what is specifically illustrated. Additionally, as shown in FIG. 5, it can be possible to use a smaller area for a bottom surface 130 of the knob assembly 106, while maintaining adequate signal discrimination and improving functionality. Thus, with every individual sensor electrode 122 having a height H and a width W, using a smaller number of overall sensor electrodes 122 while not altering the area of each sensor electrode H×W can free up additional space on the sensor grid 110 for other functions and input/output.

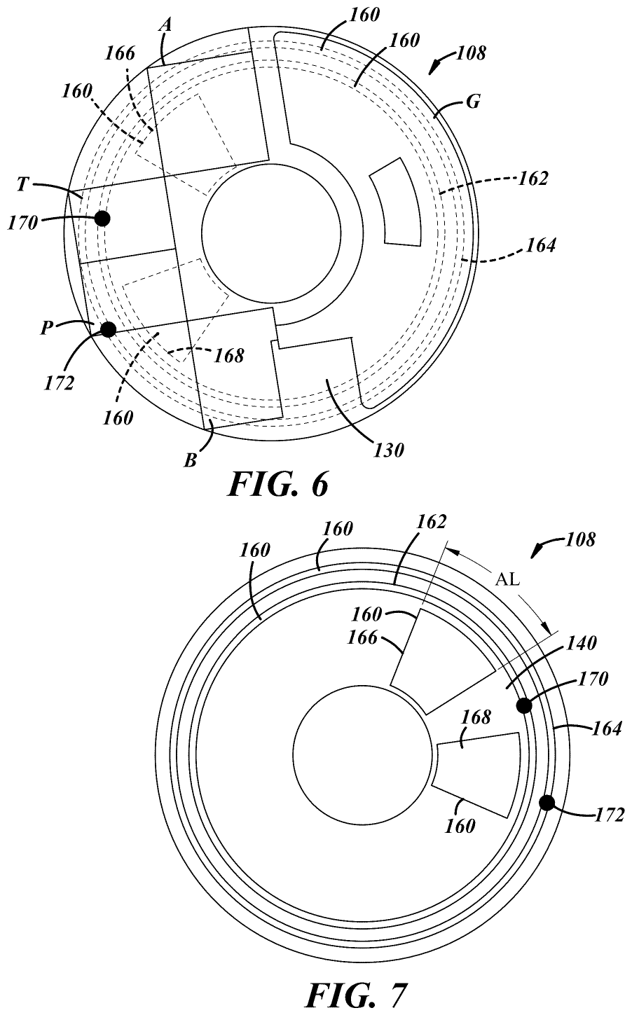

As detailed herein, it is desirable if two edge-adjacent sensor electrodes E, E are not simultaneously used for capacitive coupling through the rotatable electronic device 100. However, in order to accommodate a smaller knob assembly 106, edge-adjacent sensor electrodes 122 may need to be selectively coupled to the rotatable electronic device 100 to avoid both edge-adjacent sensor electrodes from simultaneously detecting coupled capacitance. FIG. 5 shows, in dotted lines, the position of the knob assembly 106, with the bottom surface 130 of the fixed base 108, illustrating the positions of coupling electrodes A, B, T, P, which are fixed on the bottom surface of the fixed base (also shown in FIG. 3 and FIG. 6). In the illustrated implementation, coupling electrodes A, B are used to provide input relating to rotation of the knob assembly 106, and T, P are used to provide a touch signal or push signal, respectively relating to the Z position of the knob assembly 106 with respect to the display panel 102. Additionally, in some or all of a reserved area 132, sensor electrodes 122 may be driven with a reference signal (e.g., 0 V or other DC voltage), and correspond to electrode(s) G on the bottom surface 130 of the fixed base 108, which couple to the reference signal from the underlying sensor electrodes 122 of the display panel 102. The various positions of coupling electrodes A, B, T, P, electrode G and accordingly, their corresponding sensor electrodes 122 may vary beyond what is explicitly illustrated. As detailed further below, while it can be advantageous to have the sensor electrodes 122 for T, P be edge-adjacent, they could be located in alternative positions on the grid 110, depending on the desired circuitry configuration.

Returning to FIG. 3 in conjunction with FIG. 5, the display panel 102, as TDDI display 116, is configured to provide a sensing signal 134 via sensor electrodes 122-1, 122-2, 122-3, and 122-4 to a first coupling electrode T, a second coupling electrode P, a third coupling electrode A, and a fourth coupling electrode B. The separate coupling electrodes T, P, A, B only cooperate with a single sensor electrode 122 in this embodiment, with each coupling electrode allowing for some sort of varying sensing functionality. As shown in FIG. 5, the coupling electrodes T, P, A, B are aligned with and overlie with sensor electrodes 122-1, 122-2, 122-3, 122-4, respectively. As illustrated, the coupling electrodes T, P overlie a corresponding pair of edge-adjacent E, E sensor electrodes 122-1, 122-2 of the grid 110. Accordingly, the two coupling electrodes T, P, comprise first and second edge-adjacent coupling electrodes. The coupling electrode A is diagonally adjacent D the first edge-adjacent coupling electrode T, and the coupling electrode A is remote R from the second edge-adjacent coupling electrode P. Additionally, coupling electrode B is a fourth coupling electrode that is diagonally adjacent D the second edge-adjacent coupling electrode P, and is remote R from the first edge-adjacent coupling electrode T. With this arrangement, and the grid 110 of sensor electrodes 122 being organized into rows 126 and columns 128, the first, second, third, and fourth coupling electrodes T, P, A, B are also at least partially aligned into respective rows or columns. For example, when the rotatable electronic device 100 is installed on the grid 110 with the first and second coupling electrodes T, P being aligned with and overlying sensor electrodes 122-1, 122-2 within either one single row or one single column (here, one single column 128), the third and fourth coupling electrodes A, B are both aligned with and overlying sensor electrodes 122-3, 122-4 within either a directly adjacent single row or a directly adjacent single column (here, one single column 128 having both sensor electrodes 122-3, 122-4). Again, depending on the orientation and size of the display 102 and grid 110, the orientation of the coupling electrodes T, P, A, B may vary, but the advantageously illustrated arrangement can help downsize the knob, streamline the appearance in the vehicle interior, and maintain functionality. Additionally, while T, P, A, B are used for sensing, touch, push, rotation (A/B), these are mere examples, and the coupling electrodes may be used to sense other qualities or facilitate other knob-related functionality.

In addition to the sensing signal 134, a reference signal 136 drives the sensor electrodes 122 in the reserved area 132, as mentioned above. Accordingly, in some or all of the reserved area 132, the sensor electrodes 122 may be driven with the reference signal 136 (e.g., 0 V or other DC voltage), and the electrode(s) G can receive the reference signal from the underlying grid 110. The sensing signal 134 drives the coupling electrodes T, P, A, B, and the reference signal 136 drives the coupling electrode(s) G. In the illustrated embodiment, the coupling electrodes T, P, A, B and the electrode(s) G are electrically isolated. Advantageously, however, given the tighter configuration, the rotatable electronic device 100 can operate such that the coupling electrodes T, P, A, B are electrically isolated, even though there are not intervening inactive sensor electrodes 122 (i.e., more physical separation beyond the edge-adjacent E and/or diagonally-adjacent D configurations). Additionally, one or more guard signals 138 may be provided. This may be used to essentially inactivate a particular sensor electrode 122. Guard signals 138 may also be used in conjunction with the sensing signal 134 for sensing rotation speed and direction using coupling electrodes A, B.

The fixed base 108 of the rotatable electronic device 100 includes a bottom surface 130 and a top surface 140 opposite the bottom surface. Accordingly, the bottom surface 130 directly faces the sensor grid 110 and the top surface 140 directly faces the various components of the knob assembly 106. A sidewall 142 may be provided to structurally house, or at least partially house, a rotary wheel 144 having a switch 146, a rotation translation segment 148, a bearing 150, and one or more springs 152, 154, of the knob assembly 106. Additionally, the sidewall 142 may help act as an interior structural support for a knob 156 of the knob assembly 106, which in this embodiment, comprises a conductive component 158 that covers the fixed base 108 and the remaining components of the knob assembly 108 noted above.

FIG. 6 shows the bottom surface 130 of the fixed base 108, and FIG. 7 shows the top surface 140 of the fixed base 108. As shown, the bottom surface 130 of the fixed base has the coupling electrodes T, P, A, B The coupling electrodes T, P, A, B may be integrated with the fixed base 108 or attached to or otherwise affixed to the bottom surface 130. The top surface 140 has a plurality of fixed conductive regions 160, which include fixed first and second rings 162, 164, and fixed areas 166, 168. The fixed first and second rings 162, 164 are conductive areas that are electrically connected to the coupling sensors T, P with vias 170, 172, respectively. The fixed areas 166, 168 are also conductive, and help with sensing rotation in conjunction with coupling electrodes A, B and the rotary wheel 144. The configuration of the fixed base 108 may vary from what is particularly illustrated in FIGS. 6 and 7, but advantageously, as detailed further below, the fixed base 108 facilitates signal transmission between the knob assembly 106 and the underlying sensor grid 110 of the display panel 102. In general, the fixed base 108 does not turn or rotate with respect to the display panel 102, and it is at least partially situated between the display panel 102 and the knob assembly 106, exchanging signal between the movable rotary wheel 144 and the underlying sensor grid 110.

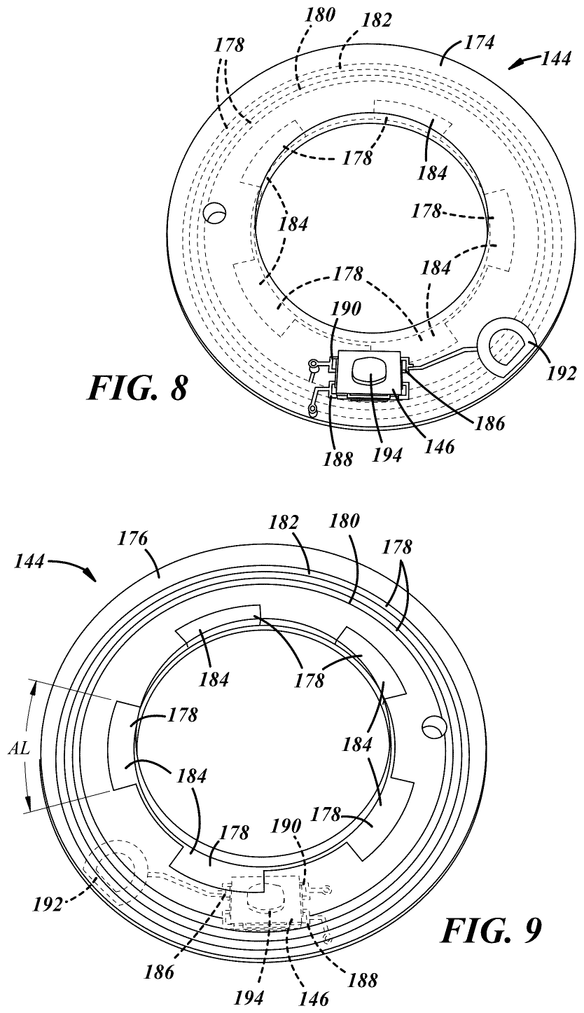

FIGS. 8 and 9 illustrate a top surface 174 and a bottom surface 176 of the rotary wheel 144, respectively. The rotary wheel 144 is a part of the knob assembly 106, and accordingly, it rotates with respect to the fixed base 108 and the display panel 102. The rotary wheel 144 includes rotatable conductive regions 178, which are configured to cooperate with the fixed conductive regions 160 and coupling electrodes T, P, A, B of the fixed base 108. The rotatable conductive regions 178 include rotatable first and second conductive rings 180, 182, as well as rotatable conductive areas 184. Rearrangements, alternative configurations, etc. for these regions 160, 178 are certainly possible, as the illustrated representation is merely an operable example. Additionally, the rotary wheel 144 may be concentric and sized similarly to the fixed base 108, or in other embodiments, the rotary wheel may be larger or smaller (e.g., in diameter) than the fixed base.

The fixed conductive regions 160 on the fixed base 108 and the rotatable conductive regions 178 on the rotary wheel 144 are designed to cooperate with each other, and ultimately, with the coupling electrodes T, P, A, B and the sensor grid 110. More particularly, in this embodiment, the first rotatable conductive ring 180 is designed to selectively pass signal to the first fixed ring 162, which is then connected with via 170 to coupling electrode T. The second rotatable conductive ring 182 is designed to selectively pass signal to the second fixed ring 164, which is then connected with via 172 to coupling electrode P. Manual rotation of the knob 156 causes concomitant rotation of the rotatable conductive regions 178, and more particularly, rotatable conductive areas 184. Rotation of the rotatable conductive areas 184 can be picked up via fixed areas 166, 168 and coupling electrodes A, B. Each of the rotatable conductive areas 184 and each of the fixed areas 166, 168 have an equal arc length AL, which, along with their radial spacing and placement relative to each other, can allow for determinations of rotation speed and direction (C, AC).

The rotary wheel 144 includes a switch 146 for selectively activating the coupling electrodes T, P. so as to minimize crosstalk between all of the sensing coupling electrodes T, P, A, B during operation of the rotatable electronic device 100. The switch 146 is advantageously a momentary single pole double throw (SPDT) switch having a common input terminal 186, along with a normally closed (NC) output terminal 188 and a normally open (NO) output terminal 190. Other configurations for the switch 146 are certainly possible, and the switch may have more inputs/outputs than what is particularly illustrated. As illustrated, the common input terminal 186 is connected to a conductive pad 192. With particular reference to FIG. 3, the conductive pad 192 is in contact with the longest metal spring 152 which itself mechanically and electrically contacts an inner surface of the conductive knob and thus able detect the capacitance or change in capacitance with respect to the conductive knob 156 when it is touched or pushed by a user. The materials for the cover 158, spring 152, various pads and electrodes, etc. are preferably chosen to operably detect and/or allow for capacitance changes. Metal-based materials can be used, as are other sufficiently conductive materials. Structurally, the spring 152 is longer than the other springs 154, all of which serve to bias the cover 158 and knob 156 away from the display panel 102. Accordingly, the conductive spring 152 serves a dual purpose in this embodiment (electrically conducting and mechanically biasing), but it is possible in other implementations to capacitively couple the user's touch to the switch input terminal 186.

The conductive spring 152 is electrically coupled to the conductive pad 192, and the common input terminal 186 of the switch 146. If the switch button 194 is not depressed, the electrical coupling will be conducted to the NC output 188, which is electrically coupled to the first rotatable conductive ring 180, the first fixed conductive ring 162, the coupling electrode T, and the underlying sensor electrode 122-1. If the switch button 194 is depressed, the electrical coupling with be conducted to the NO output terminal 190, which is electrically coupled to the second rotatable conductive ring 182, the second fixed conductive ring 164, the coupling electrode P, and the underlying sensor electrode 122-2. It should also be noted that the switch button 194 and switch 146 may have different configurations, such as a lever arm or an alternately configured button, or a different configuration of poles and throws. This particular arrangement, however, efficiently uses the T, P coupling electrodes, taking advantage of the fact that a T signal is no longer needed when the knob 156 is depressed since a push can only occur if there is a touch of the knob. This allows for the rotatable electronic device 100 to differentiate between a user who is touching and/or turning the knob 156 vs. pushing and/or turning the knob, thereby promoting functionality while minimizing sensor grid 110 space.

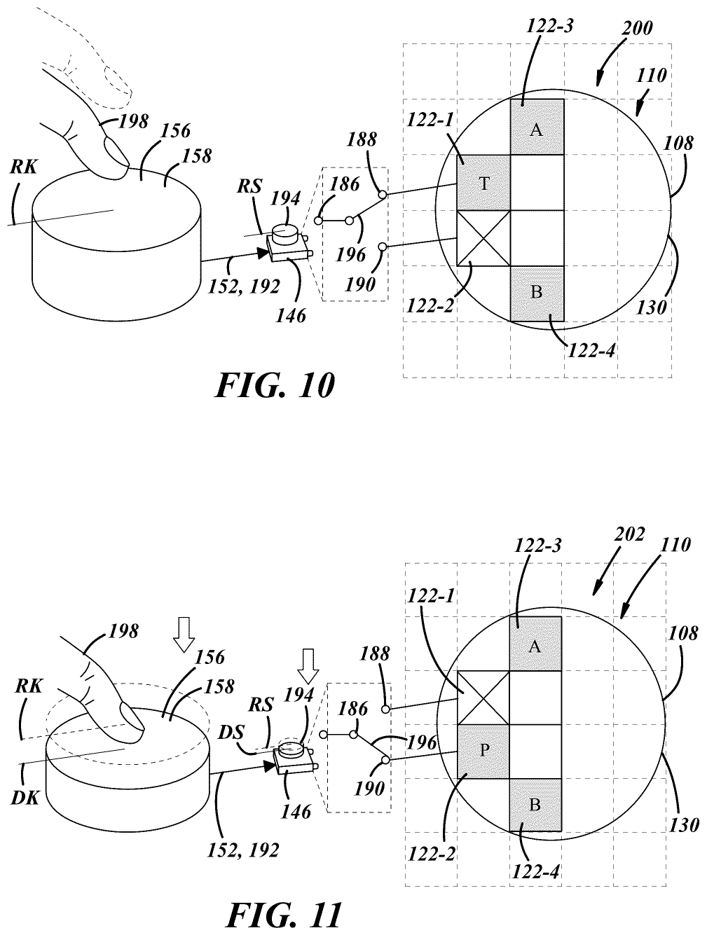

FIGS. 10 and 11 schematically illustrate an example first state 200 and second state 202 of the switch 146. More particularly, FIGS. 10 and 11 illustrate that manual depression of the knob 156 causes the switch 146 to change capacitive coupling from one of the two coupling electrodes to the other of the two coupling electrodes (e.g., first state 200 with coupling electrode T in FIG. 10 and second state 202 with coupling electrode P in FIG. 11). As discussed with respect to FIG. 3, the knob 156 is biased away from the display 102 and towards a raised position RK. Since the knob 156 is axially translatable, it can be manually moved to a depressed position DK (see FIG. 11). When the knob 156 is in the raised position RK (see FIG. 10), the switch button 194 of the switch 146 is also in a raised position RS. When the knob 156 is in the depressed position DK (see FIG. 11), the switch button 194 of the switch 146 is also depressed within the knob assembly 106, which forces the switch arm 196 to transition from the NC terminal 188 to the NO terminal 190. Accordingly, when the knob 156 is manually moved to the depressed position DK, the switch 146 is physically engaged to change it from the first state 200 to the second state 202. This, as described above with respect to the features of the rotary wheel 144 and the fixed base 108, allows for the coupling electrodes T, P to be only selectively active, avoiding simultaneous use of edge-adjacent sensor electrodes 122-1, 122-2. Accordingly, as shown in FIG. 10 when a user 198 touches the conductive cover 158, the signal passes to the T coupling electrode. When the knob 156 moves to the depressed position DK, the signal is switched from the T coupling electrode to the P coupling electrode. Additionally, in this embodiment, the touch/push state or first state 200/second state 202 can be determined using the absolute value of each input from sensor electrodes 122-1, 122-2, and/or using the difference in the values of the input from each sensor electrode 122-1. 122-2.

The switch 146 arrangement helps facilitate an external capacitive coupling to the sensor electrodes 122-1, 122-2 via coupling electrodes T, P, respectively. The user 198 serves as an external capacitive source, a capacitive source that is external to the rotatable electronic device 100 and display 102. Since the knob 156 is electrically conductive, a capacitive signal or change in capacitance may be imparted by the user 198 to the knob 156, and conducted via the spring 152, the conductive pad 192 on the rotary wheel 144, the switch 146, the rotatable and fixed conductive rings 180, 182, 162, 164, the coupling sensors T, P, and ultimately the edge-adjacent sensor electrodes 122-1, 122-2. The other coupling sensors A, B, on the other hand, utilize internal capacitive coupling to sense rotation. An internal capacitive coupling is a capacitive coupling of different sensor electrodes via one or more circuits within the knob assembly 106, and does not rely on an external capacitive source such as the user's finger. Here, manual rotation AC, C causes the rotary wheel 144 and the rotatable conductive areas 184 to rotate with respect to the fixed base 108, on which the fixed conductive areas 166, 168 serve to connect coupling sensors A, B and underlying sensor electrodes 122-3, 122-4, forming a capacitively coupled circuit from those electrodes 122-3, 122-4 through the knob assembly 108 and back down to the reference voltage sensor electrodes 132 via the G electrode of the fixed base 106.

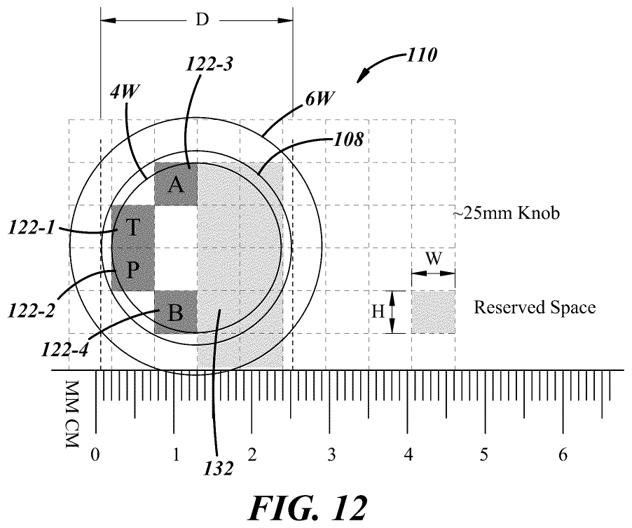

With reference to FIG. 12, the selective activation of the coupling electrodes T, P allows for the edge-adjacent sensor electrodes 122-1, 122-2 to be strategically used for sensing coupled capacitance from the electronic device 100, thereby more efficiently employing space in the sensor grid 110. This allows for a smaller diameter D for the fixed base 108 (˜24 mm in this embodiment), without sacrificing sensing functionality. In the illustrated example, each H×W for each sensor electrode 122 is approximately 5 mm×5 mm, although it is possible to have other dimensions or other shaped sensor electrodes (e.g., rectangle-shaped). However, it may be advantageous for sensor configuration to have closer to a 1:1 ratio for H: W. In such an embodiment, the lesser of W and H should be at least 0.8 times the greater of W and H. Thus, if W is 5 mm, H is between 4.0-5.0 mm. Additionally, to achieve adequate spacing and functionality amongst coupling electrodes T, P, A, B and sensor electrodes 122-1, 122-2, 122-3, 122-4, it is possible to have the diameter D of the fixed base 108 be in the range of 4 to 6 times the greater of W and H, or more particularly, in the range of 4 to 5 times the greater of W and H. This is illustrated in FIG. 12 with circles 4W and 6W. These particular size ratios help to optimize usage and functionality of the sensor grid 110 while improving detection ability.

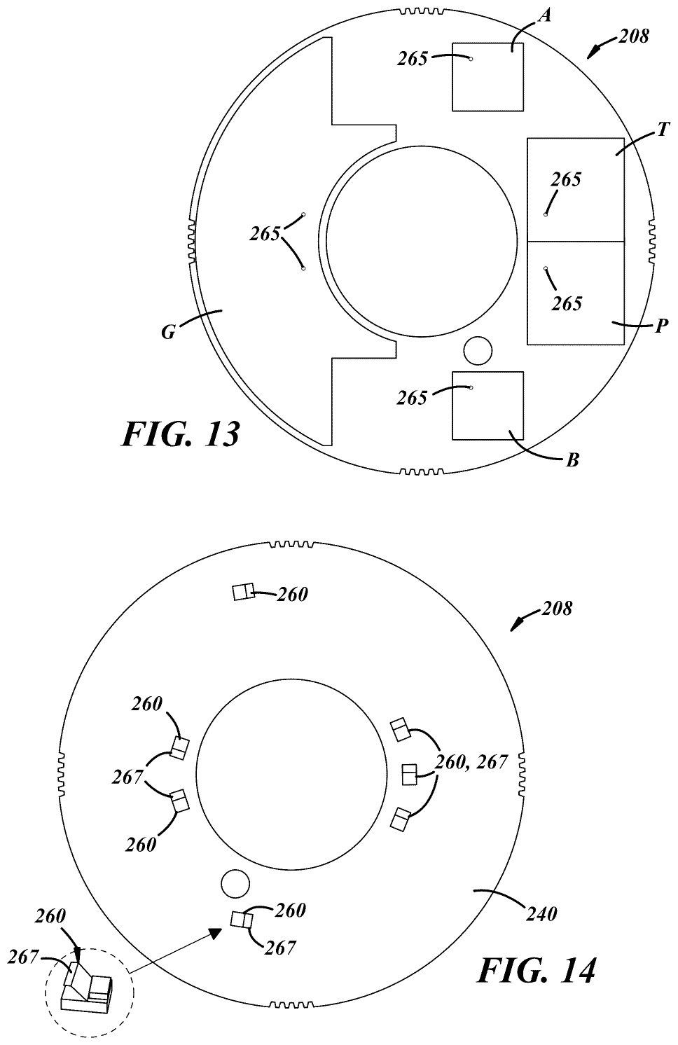

FIGS. 13 and 14 show another embodiment of the fixed base 208, with the bottom surface 230 shown in FIG. 13 and the top surface 240 shown in FIG. 14. As shown in the bottom view of FIG. 13, a plurality of through holes 265 can be provided for wiring to help connect a plurality of springs 267 that are configured to contact the rotary wheel 144. The plurality of springs 267 serve as the plurality of fixed conductive regions 260 to help create a physical coupling as opposed to an air coupling between the rotary wheel 144 and the fixed base 208. Given this physical connection, in some embodiments, it may be possible to have the coupling electrodes A, B, T, P be an integral part of each fixed conductive region 260 or spring 267 (e.g., if the spring 267 extends through the fixed base 208 through a soldering wire from the top surface 240 to the bottom surface 230).

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all the following: “A”; “B”; “C”; “A and B”; “A and C”; “B and C”; and “A, B, and C.”

1. A rotatable electronic device for installation onto a grid of sensor electrodes of a touch sensitive display panel, the grid of sensor electrodes comprising a plurality of individual sensor electrodes wherein each of the plurality of individual sensor electrodes in the grid of sensor electrodes has a plurality of adjacent sensor electrodes, including a plurality of edge-adjacent electrodes and one or more diagonally-adjacent electrodes, and wherein the rotatable electronic device comprises:
a fixed base having a bottom surface and a top surface, the bottom surface including a plurality of coupling electrodes, and the top surface including a plurality of fixed conductive regions each electrically connected to a different one of the plurality of coupling electrodes, wherein the plurality of coupling electrodes each align with and overlie at least one of the plurality of adjacent sensor electrodes when the rotatable electronic device is installed on the grid of sensor electrodes, such that two of the coupling electrodes of the plurality of coupling electrodes align with and overlie a corresponding pair of the plurality of edge-adjacent sensor electrodes of the grid of sensor electrodes; and
a knob assembly mounted over, and rotatable relative to, the fixed base, wherein the knob assembly includes a knob, a momentary switch, and a plurality of rotatable conductive regions which are configured to at least partially align with the plurality of fixed conductive regions of the fixed base, wherein manual rotation of the knob causes concomitant rotation of the plurality of rotatable conductive regions and wherein manual depression of the knob causes the momentary switch to change a coupling from one of the two of the coupling electrodes to the other of the two of the coupling electrodes to make one of the corresponding pair of the edge-adjacent sensor electrodes of the grid of sensor electrodes selectively activatable.

2. The rotatable electronic device of claim 1, wherein the two coupling electrodes comprise a first and a second edge-adjacent coupling electrode and wherein the plurality of coupling electrodes comprises a third coupling electrode that is diagonally adjacent to the first edge-adjacent coupling electrode and is remote from the second edge-adjacent coupling electrode.

3. The rotatable electronic device of claim 2, wherein the plurality of coupling electrodes comprises a fourth coupling electrode that is diagonally adjacent to the second edge-adjacent coupling electrode and is remote from the first edge-adjacent coupling electrode.

4. The rotatable electronic device of claim 3, wherein the grid of sensor electrodes is organized into rows and columns of the grid of sensor electrodes, and wherein the first edge-adjacent coupling electrode, the second edge-adjacent coupling electrode, the third coupling electrode, and the fourth coupling electrode are arranged on the fixed base such that, when the rotatable electronic device is installed on the grid of sensor electrodes with the first edge-adjacent sensor electrode and the second edge-adjacent coupling electrode are aligned with and overlying sensor electrodes within either one single row or one single column of the grid of sensor electrodes, the third and fourth coupling electrodes are both aligned with and overlying sensor electrodes within either an adjacent single row or an adjacent single column of the grid of sensor electrodes, respectively.

5. The rotatable electronic device of claim 1, wherein the knob assembly includes:
a rotary wheel having a bottom side that includes the plurality of rotatable conductive regions, the rotary wheel and the momentary switch being mounted within the knob, the knob being axially translatable between a raised position and a depressed position,
wherein the knob is biased towards the raised position and, when manually moved to the depressed position, physically engages the momentary switch to change it from a first state to a second state.

6. The rotatable electronic device of claim 5, wherein the knob is an electrically conductive knob and the plurality of rotatable conductive regions include:
a first and a second radially spaced conductive ring,
wherein the momentary switch is connected in circuit between the electrically conductive knob, the first radially spaced conductive ring, and the second radially spaced conductive ring such that, when the momentary switch is in the first state, the momentary switch electrically connects the electrically conductive knob to the first radially spaced conductive ring and,
when the momentary switch is in the second state, the momentary switch electrically connects the electrically conductive knob to the second radially spaced conductive ring.

7. The rotatable electronic device of claim 6, wherein the knob is biased towards the raised position by a plurality of metal springs and is electrically connected to the momentary switch via at least one of the plurality of metal springs.

8. The rotatable electronic device of claim 5, wherein each of the plurality of fixed conductive regions are configured to physically contact the bottom side of the rotary wheel at each of the plurality of rotatable conductive regions.

9. The rotatable electronic device of claim 1, wherein each of an individual sensor electrode of the plurality of individual sensor electrodes in the grid of sensor electrodes has a width W and a height H, and the fixed base has an outer peripheral diameter in a range of 4 to 6 times a greater of the width W or the height H.

10. The rotatable electronic device of claim 9, wherein a lesser of the width W or the height H is greater than 0.8 times, and less than 1.0 times, the greater of the width W or the height H.

11. The rotatable electronic device of claim 1, wherein the rotatable wheel and the fixed base are configured such that, when the rotatable electronic device is installed on the grid of sensor electrodes, the rotatable electronic device provides internal capacitive coupling to a first set of the plurality of individual sensor electrodes and external capacitive coupling to a second set of the plurality of individual sensor electrodes.

12. The rotatable electronic device of claim 1, wherein the plurality of coupling electrodes include a pair of rotation sensing electrodes that, when the rotatable electronic device is installed on the grid of sensor electrodes, overlie and are aligned with a corresponding pair of sensor electrodes of a first set of the plurality of individual sensor electrodes, and
wherein the plurality of coupling electrodes further include a touch coupling electrode and a push coupling electrode,
wherein, when the rotatable electronic device is installed on the grid of sensor electrodes, the touch coupling electrode and the push coupling electrode overlie and are aligned with a corresponding pair of sensor electrodes of a second set of the plurality of individual sensor electrodes.

13. The rotatable electronic device of claim 12, wherein the touch coupling electrode and the push coupling electrode comprise the two coupling electrodes that, when the rotatable electronic device is installed on the grid of sensor electrodes, align with and overlie the corresponding pair of edge-adjacent sensor electrodes of the grid of sensor electrodes.

14. An automotive display comprising the rotatable electronic device and touch sensitive display panel of claim 1.

15. The automotive display of claim 14, wherein the touch sensitive display panel is an in-cell touch and display driver integration display.
